(19) United States
(12) Patent Application Publication
(10) Pub. No.: US 2005/0255598 A1
(43) Pub. Date: Nov. 17, 2005

(54) Use of an organic compound for the absorption of ionizing radiation

(75) Inventors: Eric Broutin, Herblay (FR); Serge Cossard, Argenteuil (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SNECMA MOTEURS, Paris (FR)

(21) Appl. No.: 11/062,787

(22) Filed: Feb. 23, 2005

(30) Foreign Application Priority Data
Feb. 24, 2004 (FR) 04 01840

(51) Int. Cl. G01N 37/00

(52) U.S. Cl. 436/56; 436/57; 264/40.1

(57) ABSTRACT

Use is made of an organic compound of formula CHₙI₄₋ₙ, n being between one and three, in order to absorb ionizing radiation, preferably when its energy is greater than approximately 10 eV and more preferably still when it concerns X-rays or gamma rays. This material can be used in particular in devices for protecting from ionizing radiation and as absorbent labeling agent for radiography.

The invention relates to the field of the absorption of ionizing radiation.

Ionizing radiation, such as, for example, X-rays or gamma rays, is frequently used to take radiographs of bodies of any type and in particular of the human body.

As is known to a person skilled in the art, due to its energy, this ionizing radiation can prove to be dangerous for those who use it frequently, such as, for example, radiologists, or those who are exposed to it, such as, for example, cosmonauts or astronauts and certain people working in nuclear power plants or in the vicinity of particle accelerators.

Items of protective equipment or protective devices, such as shields or screens, composed of materials capable of at least partially absorbing ionizing radiation, thus exist. One of the most widely used absorbent materials is lead, in particular in the field of radiography. These absorbent materials generally have a high density which makes it difficult, indeed even impossible, to incorporate them in movable items of equipment, such as clothes or accessory parts. Furthermore, these absorbent materials are generally harmful to the health because of their chemical nature. In addition, as these absorbent materials are generally not transparent to visible light, they do not make it possible to directly observe the region exposed to the ionizing radiation. For example, it is not possible to use them to equip protective glasses.

Furthermore, it is also known, in particular from U.S. Pat. No. 5,242,007, to label (or impregnate or alternatively mix) bodies or substances with absorbent labels (or tracers), such as lead (Pb), thorium (Th), tantalum (Ta), hafnium (Hf), tungsten (W) or uranium (U), to facilitate their detection by radiography. As the quality of the detection depends essentially on the thickness of the labeling and on the absorbing power of the label used, the weaker the absorbing power of a label, the greater the thickness deposited has to be. In point of fact, it is not always possible to obtain a high labeling thickness, in particular in the case of an impregnation, owing to the fact that said labeling results from the introduction of the label into pores, defects, microcavities or interstices of the body which have very small dimensions. Furthermore, the greater the thickness to be deposited, the greater the increase in the weight of the labeled body, and this increase in weight is all the more pronounced if the molecular mass and the density of the label are high, which is the case with the abovementioned labels.

An aim of the invention is thus to overcome all or part of the abovementioned disadvantages.

To this end, it proposes using organic compounds of formula CHₙI₄₋ₙ, n being between one (1) and three (3), in order to absorb ionizing radiation, preferably when its energy is greater than approximately 10 eV and more preferably still when X-rays or gamma rays are involved.

This is because the Applicant Company has discovered that these compounds, and in particular iodomethane (CH₃I) and diiodomethane (CH₂I₂), exhibit a very high absorbing power for ionizing radiation, of the order of three times greater than that of lead, a low density, of the order of three times lower than that of lead, and a transparency to visible light, in particular in the liquid phase.

These properties render these organic materials particularly attractive for a great many applications and in particular in the fields of protecting from ionizing radiation and of labeling bodies for the purpose of radiographes.

For example, these materials are particularly well suited to the labeling of cores, for example made of ceramic, intended for the molding of cavities, for example of a turbomachine blade, and/or to the labeling of the residues which remain in these cavities after removal of the cores, for the purpose of a radiograph.

The invention also makes it possible to produce devices for protecting from ionizing radiation which comprise at least one component which supports a layer of CHₙI₄₋ₙ (and in particular iodomethane (n=3) or diiodomethane (n=2)) and which can be inserted between a body and a source of ionizing radiation.

Such devices can be put together in particular in the form of protective glasses, protective shields, protective helmets, protective clothes, clothing protective accessory parts or containers for sources of ionizing radiation. For example, each component of the device can define a leaktight cavity filled with CHₙI₄₋ₙ in the liquid phase, preferably undiluted, and can be made of a transparent material.

Other characteristics and advantages of the invention will become apparent when examining the detailed description below and the appended drawings, in which:

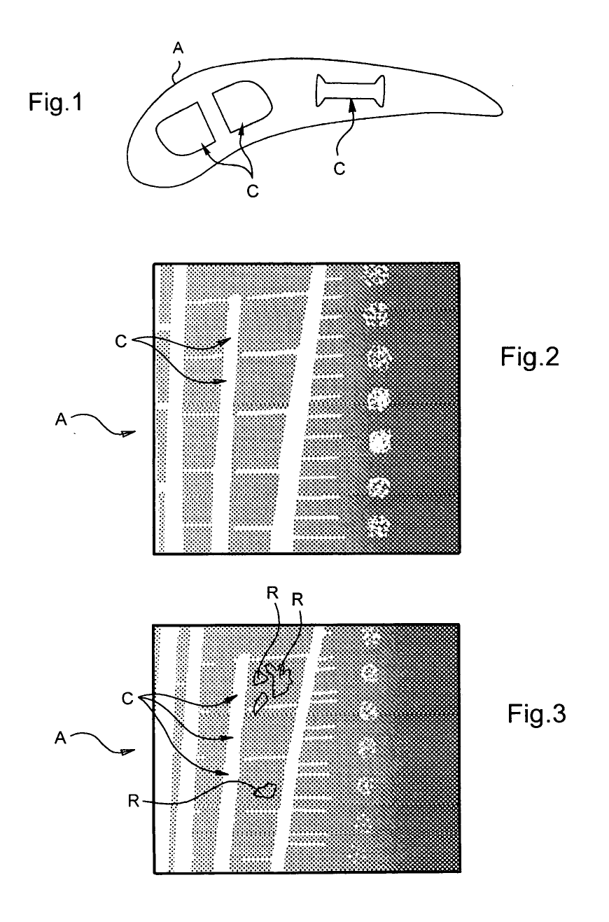

FIG. 1 illustrates diagrammatically, in a transverse sectional view, an example of the structure of a turbomachine blade,

FIG. 2 is an X-ray radiograph of a part of a blade, without labeling (or impregnation), and

FIG. 3 is an X-ray radiograph of a part of the blade of FIG. 2, after labeling (or impregnation).

The appended drawings can serve not only to illustrate the invention but can also contribute to its definition, if appropriate.

The invention relates to the use of the organic compound of formula CHₙI₄₋ₙ, n being between one (1) and three (3), for the absorption of ionizing radiation.

As indicated above, the invention results from the discovery by the Applicant Company of the very high absorbing power for ionizing radiation of CHₙI₄₋ₙ (n=1, 2 and 3), and in particular iodomethane (CH₃I, i.e. n=3) and diiodomethane (CH₂I₂, i.e. n=2), in conjunction with a low density and a transparency to visible light, in particular when it exists in the liquid phase.

More specifically, diiodomethane (CH₂I₂) exhibits a coefficient of absorption which is approximately three times greater than that of lead and a density equal to 3.4, i.e. more than three times smaller than that of lead (equal to 11.4).

The coefficient of absorption varies according to the wavelength of the ionizing radiation. It is maximum and approximately constant for photons having an energy lying within the X-ray band, that is to say for energies of between approximately 0.1 keV (kiloelectronvolt) and approximately 50 keV. Although decreasing with the wavelength, the coefficient of absorption still remains close to its maximum for photons having an energy lying within the gamma ray band, that is to say for energies of greater than approximately 50 keV. Below the X-ray band, the coefficient of absorption rapidly decreases when the wavelength increases but it remains high, however, for photons having an energy belonging to the top part of the ultraviolet band (far ultraviolet), that is to say for energies of between approximately 0.01 keV and approximately 0.1 keV.

Due to the absorbing property of diiodomethane (CH₂I₂), a thickness approximately three times smaller than that necessary with lead is needed to obtain an absorption equivalent to that of lead. Furthermore, due to the density of diiodomethane (CH₂I₂), approximately three times less diiodomethane than lead is needed to provide an equivalent protection from ionizing radiation to that conferred by lead.

The result of this is that it is possible henceforth to imagine a great many items of equipment (or devices), movable or nonmovable, for protecting from ionizing radiation and in particular protective shields, optionally for spacecraft, protective masks, protective helmets, protective clothes, such as, for example, overalls, including one-piece overalls, aprons or gloves, clothing accessory parts, such as, for example, protective inserts which can be incorporated in the pockets of clothes, or containers for sources of ionizing radiation, such as radioactive waste.

In addition, due to the transparency of CHₙI₄₋ₙ to visible light, in particular when it is in the liquid phase, it can be used to produce transparent items of protective equipment, such as, for example, protective glasses, visors or shields.

Thus, to produce a transparent protective shield, use may be made of a transparent component, for example made of glass or polycarbonate, defining a housing appropriate for receiving (or supporting) liquid CHₙI₄₋ₙ. This housing can be open on a top face when the shield is intended to be placed substantially horizontally. This results from the fact that CHₙI₄₋ₙ does not evaporate, or evaporates very little, in air. However, the housing can be completely closed and sealed and entirely filled with CHₙI₄₋ₙ in order for the item of equipment to offer a substantially uniform absorption, for example.

By way of example, a liquid diiodomethane layer with a thickness of approximately 1 mm is sufficient to absorb all the ionizing rays emitted by a source, provided that their energy is within the X-ray band.

It is important to note that the absorbing power of CHₙI₄₋ₙ is not limited to photons. It also relates to particles, such as, for example, neutrons, provided that their energy is preferably within the abovementioned energy bands (X-ray and gamma bands).

When it is used in the liquid phase, the CHₙI₄₋ₙ is preferably pure. However, it can also be mixed with one or more other materials.

The invention also has a particularly advantageous application in the field of radiography. This is because it is also possible to use CHₙI₄₋ₙ as labeling agent for bodies or substances for the purpose of radiographic observation.

For example, CHₙI₄₋ₙ can be used to observe the appearance of cavities produced in molded components, such as turbomachine blades.

As is well known to a person skilled in the art and as is illustrated in the transverse sectional view of FIG. 1, some metal turbojet blades A comprise recesses (or cavities) C produced by molding.

More specifically, to produce such blades A, metal is cast, within a mold, around cores generally made of ceramic. The cores are then removed via a chemical process referred to as “core stripping”. One disadvantage of this process is that it frequently leaves undesirable ceramic residues inside the cavities C which are difficult to observe by radiography.

In order to make it easier to observe these core residues by radiography, two techniques have been provided, in particular in U.S. Pat. No. 5,242,007. One of these techniques consists in providing a ceramic core incorporating a labeling agent (or doping agent) exhibiting a good coefficient of absorption for ionizing radiation, such as, for example, lead (Pb), thorium (Th), tantalum (Ta), hafnium (Hf), tungsten (W) or uranium (U). Thus, the core residues which remain inside the cavities after the stripping operation will comprise particles of absorbent labeling agent.

The other technique consists in immersing the blade in a bath comprising the abovementioned absorbent labeling agent, preferably after the stripping operation, so as to impregnate the microcavities (or interstices or pores or defects) of the core residues with particles of absorbent labeling agent.

Whatever the technique used, the core residues only have a chance of being observed by radiography provided that the thickness of the particles of absorbent labeling agent which impregnate them is sufficiently great. Frequently, this is only the case along a specific direction of observation, so that several exposures have to be taken in order to detect core residues.

By virtue of the invention, this problem of thickness is much less troublesome, indeed even virtually nonexistent, since the absorbing power for ionizing radiation of CHₙI₄₋ₙ is much higher than that of conventional labeling agents.

Thus, one and/or other of two abovementioned labeling techniques can advantageously be used with CHₙI₄₋ₙ and in particular with diiodomethane (CH₂I₂, n=2). However, it is generally sufficient to use only the second technique, consisting in impregnating the blade (or any other body) after stripping the cores. A comparative example of X-ray radiographs of the same part of a blade A before and after impregnation using diiodomethane is illustrated in FIGS. 2 and 3 respectively.

These radiographs were obtained using a 1.5 keV X-ray source, a current of 10 mA, a Kodak M CP film, a focus-film distance of 1200 mm, a focus of 1.5 mm×1.5 mm and an exposure time of 66 seconds. As may be observed in FIG. 3, the core residues R appear with a high contrast in the various cavities C of the blade after impregnation using diiodomethane, even though the exposure time (66 s) is low.

It is important to note, as indicated above, that CHₙI₄₋ₙ can be used as absorbent labeling agent for photon radiography, in particular in the X-ray band and in the gamma band. However, it is also possible to use it as absorbent labeling agent in producing other types of radiographs and in particular neutron radiographs.

The invention is not limited to the protective device embodiments and to the uses of CHₙI₄₋ₙ described above only by way of example but it encompasses all the alternative forms which a person skilled in the art can envisage.

1. A process for detecting by radiography, in a cavity of a molded component resulting from the removal of a molding core, the presence of residues of said core, in which said residues are labeled by a substance which absorbs ionizing radiation, characterized in that said substance is a compound of formula CHₙI₄₋ₙ in which n is between 1 and 3.

2. The process as claimed in claim 1, characterized in that said compound is incorporated in the core before the molding.

3. The process as claimed in claim 1, characterized in that said compound is incorporated in the core residues after removal from the mold.

4. The process as claimed in either of claims 2 and 3, characterized in that said compound is introduced into pores or interstices of the core or of the residues.

5. The process as claimed in one of claims 2 to 4, characterized in that said compound is incorporated by immersion of the core or of the molded component in a liquid comprising said compound.

6. The process as claimed in one of the preceding claims, characterized in that said core is made of a ceramic material.

7. The process as claimed in one of the preceding claims, characterized in that said molded component is a turbomachine blade.

8. The process as claimed in one of the preceding claims, characterized in that said ionizing radiation exhibits an energy of greater than approximately 10 eV.

9. The process as claimed in one of the preceding claims, characterized in that said ionizing radiation belongs to a group comprising X-rays and gamma rays.

10. The process as claimed in one of the preceding claims, characterized in that said compound is diiodomethane.

11. The process as claimed in one of claims 1 to 9, characterized in that said compound is iodomethane.
